(19) United States
(12) Patent Application Publication
(10) Pub. No.: US 2010/0074074 A1
(43) Pub. Date: Mar. 25, 2010

(54) METHOD AND APPARATUS FOR RECORDING OPTICAL INFORMATION, AND METHOD AND APPARATUS FOR REPRODUCING OPTICAL INFORMATION

(75) Inventors: Masahiro Kanamaru, Kanagawa (JP); Kazuki Matsumoto, Kanagawa (JP); Rumiko Hayase, Kanagawa (JP); Satoshi Mikoshiba, Kanagawa (JP); Norikatsu Sasao, Tokyo (JP); Takahiro Kamikawa, Kanagawa (JP); Masaya Terai, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/547,872

(22) Filed: Aug. 26, 2009

(30) Foreign Application Priority Data
Sep. 25, 2008 (JP) 2008-246722

(51) Int. Cl. G11B 20/00; G11B 7/00

(52) U.S. Cl. 369/47.15; 369/100; G9B/20; G9B/7

(57) ABSTRACT

An optical information recording apparatus includes a first optical system that radiates an information beam that carries information onto a recording medium; a second optical system that radiates reference beams onto the recording medium; a radiation position specifying unit that specifies a plurality of recording spots positioned within a radiation range of the reference beams; and an incident angle obtaining unit that specifies an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot.

### CROSS-REFERENCE TO RELATED APPLICATIONS

This application is based upon and claims the benefit of priority from the prior Japanese Patent Application No. 2008-246722, filed on Sep. 25, 2008; the entire contents of which are incorporated herein by reference.

### BACKGROUND OF THE INVENTION

1. Field of the Invention

The present invention relates to an optical information recording method, an optical information reproducing method, an optical information recording apparatus, and an optical information reproducing apparatus.

2. Description of the Related Art

In the field of techniques for recording and reproducing hologram-type optical information, a technique called angle multiplexing has conventionally been known. According to this technique, during a recording process, a plurality of pieces of information are multiplexed into mutually the same recording spot by changing the angle of a hologram recording medium little by little, with respect to a reference beam and an information beam.

For example, JP-A 2003-337524 (KOKAI) describes, as a technique related to hologram recording and reproducing processes, recording a plurality of pieces of information into mutually the same recording spot by changing the angle of a recording medium in a relative manner with respect to an information beam and a reference beam.

In addition, for example, JP-A 2007-305201 (KOKAI) describes recording another piece of information into a position that is away from a recording spot by a distance equal to or shorter than the size of the Fourier plane of an information beam, by changing the incident angle of a reference beam.

According to the hologram recording and/or reproducing methods described in the above two documents, it is possible to enhance the recording density by using a plurality of reference beams that have mutually different incident angles. These methods are called angle multiplexing methods.

However, the techniques according to the hologram recording method and the like that are described in the documents have a problem where, when the information is read from one recording spot, if a radiation range of a reference beam reaches another recording spot that is positioned adjacent to the recording spot, noise occurs from the hologram recorded in the adjacent recording spot.

### SUMMARY OF THE INVENTION

According to one aspect of the present invention, an optical information recording apparatus includes a first optical system that radiates an information beam onto a recording medium; a second optical system that radiates a plurality of reference beams onto the recording medium; a radiated position specifying unit that specifies a plurality of recording spots positioned within a radiation range of the reference beams, when an incident angle of the reference beams at which the reference beams become incident onto the recording medium is a largest one among all incident angles of the reference beams; an incident angle specifying unit that specifies an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of the information beam on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; and a controlling unit that controls the reference beams becoming incident at the incident angle of the reference beams specified by the incident angle obtaining unit.

According to another aspect of the present invention, an optical information reproducing apparatus includes a second optical system that radiates a reference beams onto a recording medium; a radiation position specifying unit that specifies positions of a plurality of recording spots positioned within a radiation range of the reference beams, when an incident angle of the reference beams at which the reference beams becomes incident onto the recording medium is a largest one among all incident angles of the reference beams; an incident angle obtaining unit that specifies an incident angle of the reference beams that is used for recording an i'th interference fringe into a second recording spot adjacent to a first recording spot, as a value obtained by adding a product of 1/(1+m) and an absolute value of a difference between an incident angle of a first reference beams used for recording an i'th interference fringe into the first recording spot and an incident angle of a second reference beams used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of an information beam radiated on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; a controlling unit that controls so that the information beam and the reference beams are radiated to a radiation position specified by the position obtaining unit and so that the reference beams become incident onto the recording medium at the incident angle of the reference beams specified by the incident angle obtaining unit; and a diffracted beam separating unit that separates diffracted beams that are output from the recording medium as a result of the reference beams controlled by the controlling unit, so that the separated diffracted beams respectively correspond to the positions of the recording spots.

According to still another aspect of the present invention, an optical information recording method includes specifying a plurality of recording spots positioned within a radiation range of reference beams, when an incident angle of the reference beams at which the reference beams become incident onto a recording medium is a largest one among all incident angles of the reference beams; specifying an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of the information beam on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; and controlling so that the information beam and the reference beams are radiated to the specified radiation position of the recording spots and so that the reference beams becomes incident onto the recording medium at the incident angle of the reference beams specified by the incident angle specifying.

According to still another aspect of the present invention, an optical information reproducing method includes obtaining positions of a plurality of recording spots positioned within a radiation range of reference beams, when an incident angle of the reference beams at which the reference beams become incident onto a recording medium is a largest one among all incident angles of the reference beams; specifying an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of an information beam radiated on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; controlling so that the information beam and the reference beams are radiated to the specified radiation positions of the recording spots and so that the reference beams become incident onto the recording medium at the incident angle of the reference beams specified by the incident angle specifying; and separating diffracted beams that are output from the recording medium as a result of the controlled reference beams, so that the separated diffracted beams respectively correspond to the positions of the recording spots.

### BRIEF DESCRIPTION OF THE DRAWINGS

FIG. 1 is a drawing for explaining an exemplary configuration of an optical system that realizes an angle multiplexing method;

FIG. 2 is a schematic drawing of an exemplary configuration of an optical information reproducing method that employs the angle multiplexing method; FIG. 3 is a drawing for explaining a polytopic multiplexing method;

FIG. 4 is a drawing for explaining recording spots on a recording medium 1;

FIG. 5 is a drawing for explaining groups each of which is made up of a plurality of books;

FIG. 6 is a drawing for explaining identifiers used for identifying incident angles of a reference beam;

FIGS. 7A and 7B are drawings for explaining angle differences corresponding to mutually different pages while the incident angle of a reference beam is changed;

FIG. 8 is a drawing for explaining incident angles of a reference beam corresponding to mutually different books;

FIG. 9 is a drawing for explaining the order in which books are recorded on one track; and

FIG. 10 is another drawing for explaining the order in which books are recorded on one track.

### DETAILED DESCRIPTION OF THE INVENTION

Exemplary embodiments of the present invention will be explained with reference to the accompanying drawings. In the description of the exemplary embodiments below, a “size of a hologram” denotes a “size of the Fourier plane” of an information beam.

Before explaining the exemplary embodiments of the present invention, a schematic configuration of a hologram optical information recording apparatus will be explained so that the exemplary embodiments can be easily understood.

### <Holographic Beam Recording/Reproducing Apparatus>

Generally, an optical recording/reproducing apparatus that uses holography is configured so as to cause an information beam to which information is given as a two-dimensional pattern to interfere with a reference beam on the inside of an optical recording medium so that the information is recorded as interference fringes. During a reproducing process, only a reference beam is radiated onto the recorded interference fringes, so that the recorded information can be extracted as a two-dimensional pattern of a diffracted image from the interference fringes. Thus, an advantageous effect is achieved where it is possible to input and output information at a high speed. Further, in particular, in an optical recording/reproducing apparatus that uses digital volume holography, interference fringes are recorded in a three-dimensional manner by positively utilizing the thickness direction of an optical recording medium. As a result, certain characteristics are realized where it is possible to improve diffraction efficiency, to record information into mutually the same area inside the optical recording medium in a multiplexed manner, and to increase the recording capacity.

### <An Optical Information Recording Apparatus Employing an Angle Multiplexing Method (a Medium Rotation Multiplexing Method)>

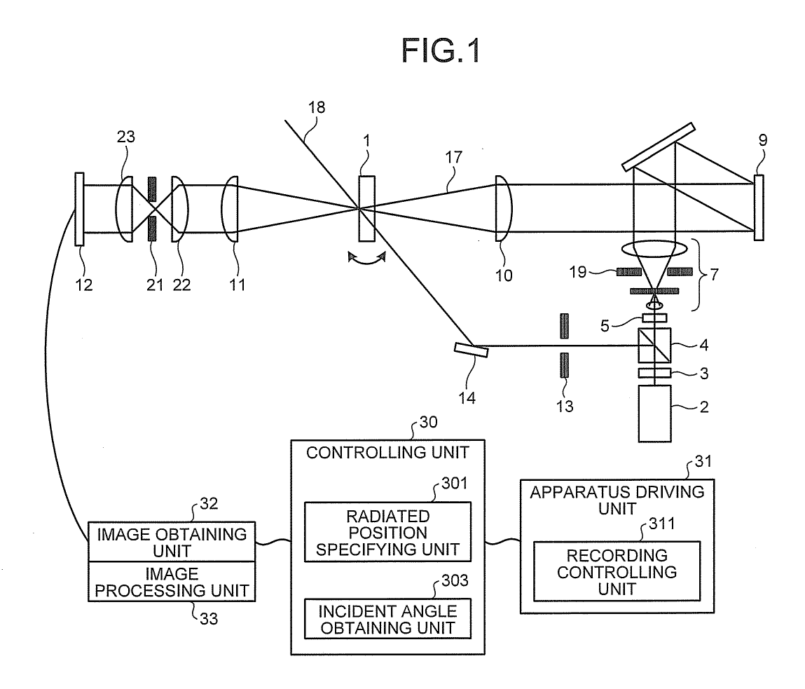

FIG. 1 is a drawing of an exemplary hologram-type optical information recording method according to an embodiment. The configuration shown in FIG. 1 includes: a recording medium 1, a light source device 2, a λ/2 wavelength plate 3, a polarized beam splitter 4, a wavelength plate 5, a beam expander 7, a spatial light modulator 9, a lens 10, another lens 11, an image sensor 12, a slit 13, a mirror 14, a shutter 19, an opening 21, yet another lens 22, a relay lens 23, a controlling unit 30, an apparatus driving unit 31, an image obtaining unit 32, and an image processing unit 33. Interference fringes that are generated when an information beam 17 and a reference beam 18 become incident onto the recording medium 1 are recorded onto the recording medium 1. That is how the information is recorded.

It is preferable to use a laser having high coherence as the light source device 2 shown in FIG. 1. A beam emitted from the light source device 2 is divided into two beams by the polarized beam splitter 4. In this situation, the λ/2 wavelength plate 3 is disposed immediately after the emission point so that it is possible to adjust the intensity ratio. Also, the optical system is configured so that it is possible to rotate the polarized beams that have passed the polarized beam splitter by using the wavelength plate 5. The beams are further expanded and shaped by the beam expander 7 so as to form a parallel light flux, before being radiated onto the spatial light modulator 9. The spatial light modulator 9 is caused to display two-dimensional data. The beams that are reflected by the spatial light modulator 9 displaying the information pass through the lens 10 and are radiated onto the recording medium as a beam that is shaped to have a beam waist. This beam is called the information beam 17.

The other beam that has been reflected by the polarized beam splitter 4 is further reflected by the mirror 14, passes through a lens, and is radiated onto the recording medium 1. This beam is called the reference beam 18.

Within the recording medium 1, the information beam 17 and the reference beam 18 overlap each other so that interference fringes are generated, the interference fringes reflecting the conditions under which the information has been recorded such as the incident angles, the wavefronts, and the wavelengths of the information beam 17 expressing an information pattern displayed by the spatial light modulator 9 and the reference beam 18. As a result, a hologram is radiated onto the recording medium. After that, by causing the spatial light modulator 9 to display a different piece of information and rotating the recording medium 1, the reference beam 18 is caused to become incident onto the recording medium 1 in such a manner that the incident angle is different from the last time, but the information is recorded into the same recording spot. Because the hologram has angle selectability, it is possible to separate and reproduce the pieces of information, by changing the incident angle of the reference beam 18. Consequently, it is possible to record the pieces of information into the one recording spot in a multiplexed manner.

The controlling unit 30 controls the apparatus driving unit 31, the image obtaining unit 32, and the image processing unit 33. The controlling unit 30 includes a radiation position specifying unit 301 and an incident angle obtaining unit 303. The radiation position specifying unit 301 specifies positions of recording spots on the recording medium. The incident angle obtaining unit 303 specifies the incident angles of the reference beam 18 that respectively correspond to the pieces of information that are recorded into one recording spot in a multiplexed manner.

The apparatus driving unit 31 includes a recording controlling unit 311. The recording controlling unit 311 records information by causing the reference beam 18 obtained by the incident angle obtaining unit 303 to be radiated into the position of the recording spot that has been specified by the radiation position specifying unit 301.

The recording controlling unit 311 controls the incident angle of the reference beam 18 by, for example, changing the angle of the recording medium 1 with respect to the reference beam 18. Another arrangement is acceptable in which the recording controlling unit 311 changes the incident angle at which the reference beam 18 becomes incident onto the recording medium 1 by changing the angle of the mirror 14, instead of changing the angle of the recording medium 1. The apparatus driving unit 31 also controls the position of the opening 21.

### <An Optical Information Reproducing Apparatus Employing the Angle Multiplexing Method (the Medium Rotation Multiplexing Method)>

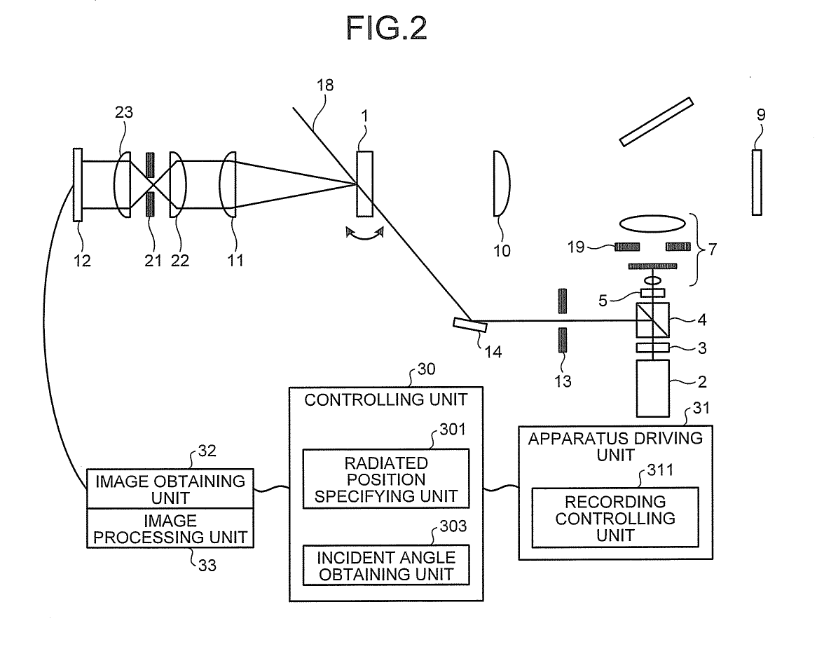

The configuration of the apparatus shown in FIG. 2 is the same as the one shown in FIG. 1. When the information is reproduced, only the reference beam is used. Thus, the information beam 17 is blocked by using, for example, the shutter 19. When the reference beam 18 is caused to become incident onto the recording medium at a certain incident angle, the beam is diffracted by the interference fringe that has been recorded by the reference beam 18 having the same angle during the recording process. The diffracted beam then forms an image on the image sensor 12 so that the information is reproduced. By rotating the recording medium 1, it is possible to change the incident angle at which the reference beam 18 becomes incident onto the recording medium 1. As a result, it is possible to separate and reproduce the pieces of information that have been recorded by using the angle multiplexing method.

In this situation, the recording medium 1 has a plurality of recording spots within the radiation range of the reference beam 18. Thus, with respect to one incident angle of the reference beam 18, a plurality of diffracted beams are output. Accordingly, the diffracted beams are separated from one another by the opening 21 in correspondence with the mutually different recording spots, respectively.

The opening 21 is configured with a polytopic filter. FIG. 3 explains a polytopic multiplexing method that employs the polytopic filter. In the case where holograms are spatially multiplexed within a recording medium, it is possible to enhance the recording density by arranging a plurality of recording spots within the radiation range of the reference beam 18 and selectively separating the holograms from one another by using the opening 21. The size of the opening 21 is configured so as to be equal to the size of each of the holograms recorded on the recording medium. More specifically, the smaller the opening 21 is, the higher is the density with which books are recorded. A disadvantage is, however, that the smaller the opening 21 is, the smaller the Signal-to-Noise Ratio (SNR) is. Generally, the size of the opening 21 is approximately 0.5 millimeters to 2.0 millimeters. The size may slightly vary depending on the spatial light modulator 9 and the lens system that are used.

The position control of the opening 21 is executed by the apparatus driving unit 31. An image formed on the image sensor 12 by the diffracted beams that have been separated by the opening 21 is obtained by the image obtaining unit 32 and processed by the image processing unit 33. As a result, the recorded information is reproduced.

### <Explanation of a Process to Record the Information>

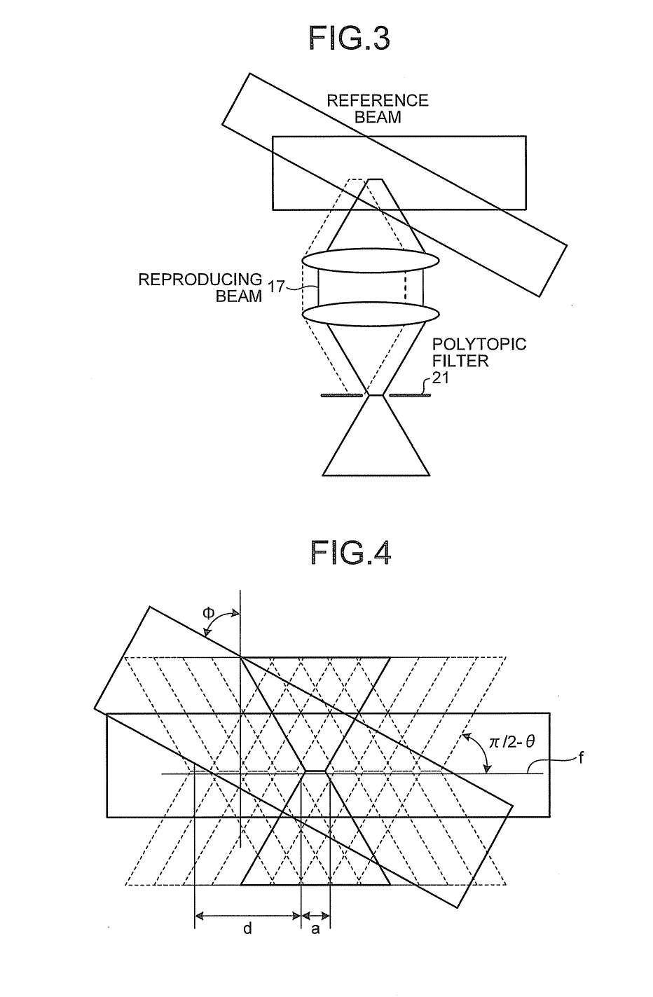

In FIG. 4, each of the intervals (i.e., shift distances) between the recording spots is expressed as “a”. The value “a” is configured so as to be equal to or larger than the size of the hologram generated by the information beam. It is preferable to configure the value “a” so as to be larger than the size of the Fourier plane of the information beam.

A plane “f” is defined as a plane that extends parallel to the recording medium and that contains a position (hereinafter, a “beam waist position”) in which the information beam system becomes the smallest within the recording medium when the incident angle of the reference beam is the largest. To make it easier to understand, the drawing in FIG. 4 is drawn in such a manner that the plane “f” does not match the beam waist plane of the information beam; however, according to the present embodiment, the beam waist plane of the information beam is contained in the plane “f”. On the plane “f”, the shortest distance between an edge of the beam waist of the information beam and a point at which the reference beam is radiated onto the recording medium is expressed as “d”. Further, the smallest integer that is larger than d/a is expressed as “m”. The value “m” denotes the maximum number of books that can make an impact on the process of reading the information from one of the books.

The maximum number of books that can make an impact on the reading process varies depending on the length of the intervals between the recording spots. More specifically, the value “m” denotes the number of recording spots that are contained in the shortest distance between an edge of the beam waist of the information beam and the radiation range of the reference beam on the recording medium.

According to the present embodiment, information corresponding to N pages is recorded into a j'th recording spot by using the angle multiplexing method. The recorded information will be referred to as a j'th book. In addition, in the same manner, information corresponding to N pages is recorded into another recording spot that is away from the j'th recording spot by the distance “a”, by using the angle multiplexing method. The recorded information will be referred to as a (j+1)'th book.

The position of each of the books is determined by the radiation position specifying unit 301. The incident angle obtaining unit 303 obtains the incident angles at which the reference beam and the information beam become incident onto the recording medium when the angle multiplexing method is applied to each of the books. The recording controlling unit 311 causes the information beam and the reference beam to be radiated into the positions that have been determined by the radiation position specifying unit 301, at the incident angles that have been obtained by the incident angle obtaining unit 303.

In this situation, the incident angle of the reference beam used for an i'th page in the (j+1)'th book is configured so as to be a value obtained by adding the product of 1/(1+m) and the difference between the incident angle of the reference beam used for the i'th page in the j'th book and the incident angle of the reference beam used for an (i+1)'th page in the j'th book, to the incident angle of the reference beam used for the i'th page in the j'th book. Further, a position that is away from the previous position of the information beam by the distance “a” is specified as the next recording spot, so that the information is recorded therein by using the angle multiplexing method.

The operation described above is performed up to a (j+m)'th book. In other words, the incident angles of the reference beam used for the pages in a (j+m+1)'th book are respectively equal to the incident angles of the reference beam used for the pages in the j'th book. With this arrangement, during the information reading process, it is possible to reduce the impact from the books that are positioned near the book radiated by the reference beam.

### <Explanation of Angle Dependency of Signal Beams>

When a focus is placed on one of the tracks on the recording medium, information is recorded into a recording spot on the track, while the incident angle of the reference beam is configured so as to be θ1_1. In this situation, in an expression θi_j, “i” is a value indicating a book, whereas “j” is a value indicating a page number within the book.

In the case where the information beam 17 is incident onto the recording medium 1 perpendicularly, the incident angle of the reference beam 18 is equal to the angle at which the reference beam 18 intersects the information beam 17 (hereinafter, the “intersection angle of the reference beam 18 and the information beam 17”). The angle selectability of the recorded hologram is determined by the thickness L of the recording medium, the intersection angle of the information beam 17 and the reference beam 18, and the wavelength used by the light source device 2. When the light source device 2 and the thickness L of the recording medium are fixed, the larger the intersection angle is, the higher the angle selectability of the recorded hologram is. Thus, the angle selectability of the signal beam while the information is reproduced from the recording medium can be expressed as in Expression (1) shown below:

$$η ( θ , L , Δ θ ) = {( \frac{π nL}{λ cos ( θ )} )}^{2} sin {c ( \frac{2 nL sin ( θ )}{λ} Δ θ )}^{2} \qquad ( 1 )$$

In Expression (1), L denotes the thickness of the recording medium, whereas λ denotes the wavelength of the reference beam 18, while n denotes the refractive index of the recording medium, and θ denotes the intersection angle of the information beam 17 and the reference beam 18. Expression (1) is based on a sinc function and exhibits side peaks periodically. Thus, to record another page that is positioned adjacent to one page, it is desirable to configure the incident angle of the reference beam 18 so as to be equal to the angle of a trough of the side peak for the one page.

The angles of the troughs will be sequentially referred to as the first Null, the second Null, and so on, starting with the one closest to a center peak. To increase the recording capacity, it is most desirable to record information by using the first Null angle. However, to reduce the noise from adjacent pages on which the reference beam 18 is radiated, it is better to record information by using the second Null angle.

Consequently, the information on the second page is recorded at the second Null angle θ2 used for the first page. In the present example, it is assumed that θ1_i<θ1_i+1 is satisfied. The information on the third page is recorded at the second Null angle θ3 used for the second page. By repeating this process, the information on the N pages is recorded. The range of the angles at which the reference beam can be radiated is determined by the Numerical Aperture (NA) of the lens 10 and the beam system of the reference beam. When the information on the N pages has been recorded, the recording spot is moved by a distance that is equal to or longer than the size of the hologram generated by the information beam.

More specifically, a set made up of the pages that have been recorded in one recording spot will be referred to as a book. In particular, the book recorded first will be referred to as the first book. After the information beam 17 is moved by a distance that is equal to or longer than the size of the hologram, information on different pages is further recorded. At that time, the incident angle of the reference beam 18 is arranged to be different from the incident angle used for the first book.

When θ denotes the angular aperture of the lens 10, while φ denotes the largest incident angle of the reference beam, and L denotes the thickness of the recording medium, the shortest distance between an edge of the information beam 17 and an edge of the radiation range of the reference beam 18 can be expressed by using Expression (2) shown below:

$$d = \frac{L}{2} ( tan θ + tan φ ) \qquad ( 2 )$$

In Expression (2), “a” denotes the moving distance of the recording spot. The moving distance is dependent on the size of the opening 21. In other words, the position of the opening 21 is in a conjugate relationship with the recording medium. For example, it is preferable to configure the opening size of the opening 21 so as to be equal to the size of the Fourier plane of the information beam 17 on the recording medium.

Depending on the lens 11 and the lens 22 that are shown in FIG. 2, the size of the opening 21 may be larger or smaller than the size of the Fourier plane. In the present example, to make the explanation simple, it is assumed that, when the focal distance of the lens 11 is configured so as to be equal to the focal distance of the lens 22, the size of the opening 21 is equal to the size of the Fourier plane.

When the opening size of the opening 21 is configured so as to be smaller than the size of the Fourier plane of the information beam 17 on the recording medium 1, high-frequency components of the reference beam 18 serving as a reproducing beam are eliminated, and the beam is thus what is called an “out of focus” state. In that situation, however, it is also possible to complement the high-frequency components of the reproducing beam by performing a signal processing process and to reduce the noise. With this arrangement, it is possible to multiplex books by using a small shift distance and to increase the recording capacity. In this situation, the distance “a” is defined so as to be smaller in proportion to how much the opening 21 is arranged to be smaller. In other words, a book is a set made up of the pages that are multiplexed onto a Fourier plane having the smallest size and are separatable by using the opening 21.

Generally, the value “m” satisfies m=2, m=3, or the like. The larger the value L is, or the larger the angular aperture NA of the lens 10 is, or the smaller the size of the hologram is, the larger is the value m.

According to the present embodiment, the incident angle of the reference beam used for the first page in the second book is configured so as to be different from an incident angle θ1_1 of the reference beam used for the first book. More specifically, the incident angle of the reference beam used for the first page in the second book is configured so as to be a value obtained by adding the product of 1/(m+1) and the difference between the first and the second pages in the first book (i.e., (01_2−θ1_1)/(m+1)) to θ1_1. Another arrangement is acceptable in which the incident angle of the reference beam for the first page in the second book is configured so as to be a value obtained by subtracting θ1_1 from the product of 1/(m+1) and the difference.

Based on the incident angle θ2_1 calculated in this manner, the pages are recorded so that the second page in the second book is recorded at the second Null angle, in the same manner as the first book was recorded. In this situation, the differences between the incident angles used for mutually different pages in the second book are configured so as to be equal to the differences between the incident angles used for the first book. After the N pages in the second book have been recorded, another point that is away from the recording point for the second book by the size of the hologram is used for recording the third book. An incident angle θ3_1 of the reference beam used for the first page in the third book is a value obtained by adding (θ2_2−θ2_1)/(m+1) to the incident angle θ2_1 of the reference beam used for the first page in the second book. In the case where the incident angle of the reference beam used for the first page in the second book is specified by using the result of the subtraction, the incident angle θ3_1 is also specified by using the result of a subtraction.

After the process for each of the books has been performed up to a (1+m)'th book, the incident angle of the reference beam used for the first page in a (2+m)'th book is configured so as to be equal to the incident angle used for the first book. With this arrangement, it is possible to reduce the impact of the reference beam on the books that are positioned nearby. For a (3+m)'th book and the books thereafter, the incident angles of the reference beam 18 are specified in the same manner as for the first book and the books thereafter.

### <Explanation of the Groups>

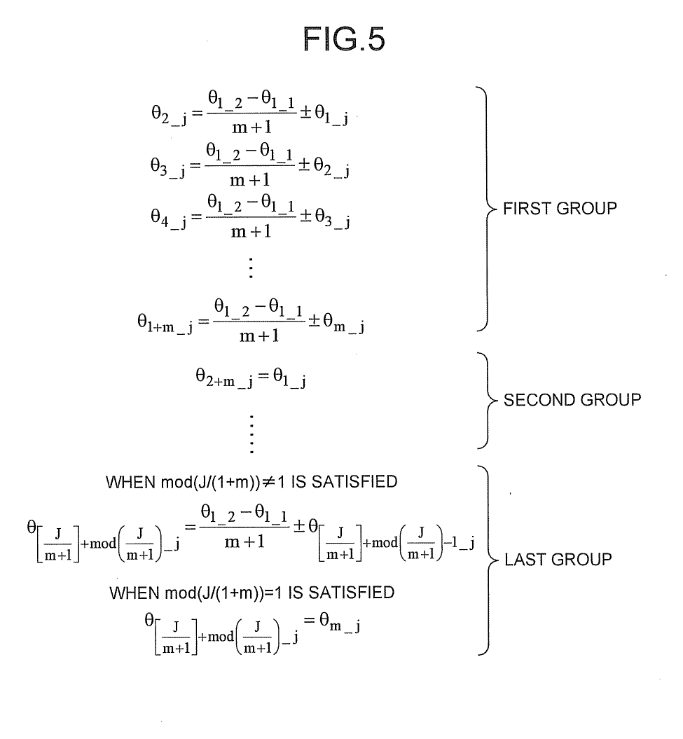

In FIG. 5, the books from the first book to the (1+m)'th book form the first group. The (2+m)'th book and as many books as the value “m” following the (2+m)'th book form the second group. After that, groups are formed up to an n'th group in the same manner, so that each of the groups is formed by as many books as (m+1).

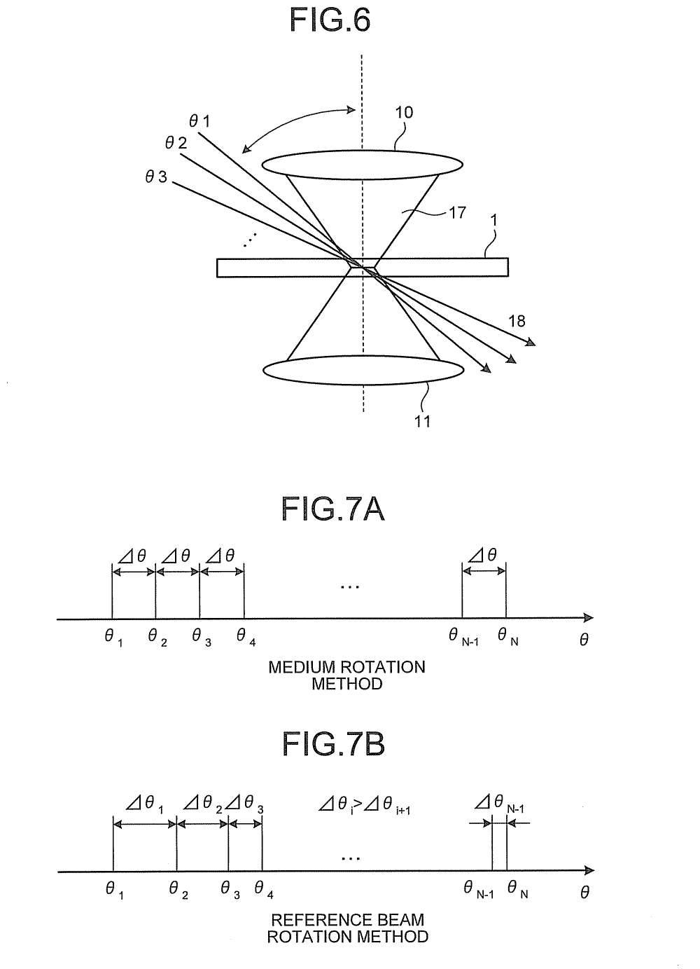

In FIG. 6, the identifiers θ1, θ2, and so on are assigned to the incident angles respectively, in the ascending order of the incident angles. The holograms that are recorded in correspondence with the mutually different incident angles of the reference beam will be referred to as the first page, the second page, and so on. In this situation, the angle selectability of the i'th page is higher than the angle selectability of the (i+1)'th page. Thus, there is a possibility that the recording angles for two or more pages within one group may be the same as one another. However, because this possibility is extremely low for all the pages, it is possible to sufficiently achieve the advantageous effect of the present embodiment.

### <Changes in the Incident Angle of the Reference Beam by the Medium Rotation Method and the Reference Beam Rotation Method>

FIG. 7A is a drawing for explaining the angle differences when the incident angle of the reference beam is changed by using the medium rotation method. In FIG. 7A, because the intersection angle of the information beam 17 and the reference beam 18 is constant, the angle selectability for each of the pages is constant. According to the medium rotation method, the angles for recording pages are uniformly varied by (θ1_2−θ1_1)/(1+m) for mutually different books. With this arrangement, there is no possibility that, within each of the groups, the incident angles of the reference beam used for mutually different pages may be the same as one another. Consequently, it is possible to record excellent holograms.

FIG. 7B is a drawing for explaining the reference beam rotation method by which pages are recorded in an angle multiplexing manner while the incident angle of the reference beam is changed. According to this method, different pages have different angle selectability.

### <Explanation of the Incident Angles of the Reference Beam Corresponding to Mutually Different Books>

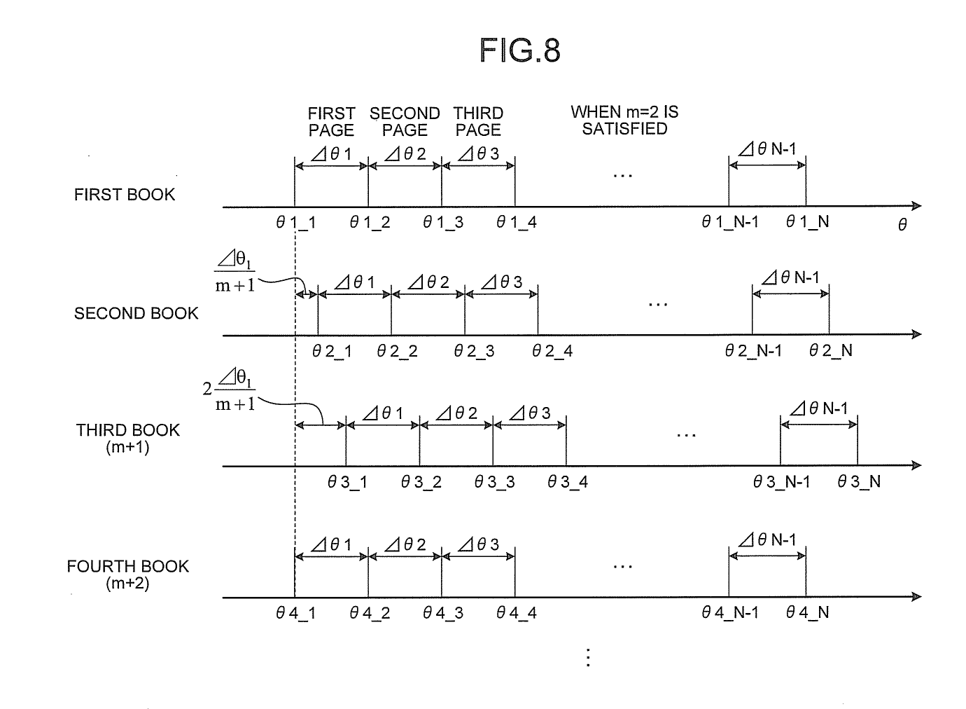

In FIG. 8, an example in which m=2 is satisfied is shown. In FIG. 8, the incident angle of the reference beam corresponding to each of the pages in the second book is a value obtained by adding Δθ1/(m+1) to the incident angle of the reference beam used for the corresponding one of the pages in the first book. Also, the incident angle of the reference beam corresponding to each of the pages in the third book is a value obtained by adding Δθ1/(m+1) to the incident angle of the reference beam used for the corresponding one of the pages in the second book and is a value obtained by adding 2Δθ1/(m+1) to the incident angle of the reference beam used for the corresponding one of the pages in the first book.

Further, in FIG. 8, the incident angle of the reference beam corresponding to each of the pages in the fourth book is equal to the incident angle of the reference beam used for the corresponding one of the pages in the first book.

### <The Incident Angles of the Reference Beam for a Book Positioned at an End of a Track>

In the case where the remainder obtained by dividing the number of books on one track by (1+m) is 1, the pages in the first book on the track are recorded by using the same set of angles as the set used for the pages in the last book on the track. This applies to both when the medium rotation method is used and when the reference beam rotation method is used. In that situation, by configuring the set of incident angles of the reference beam used for the last book so as to be equal to the set of incident angles of the reference beam used for an m'th book, it is possible to avoid the situation in which the set of angles used for recording the pages in the first book is the same as the set of angles used for recording the pages in the last book. It should be noted, however, that it is not possible to avoid the situation when m=1 is satisfied.

<The Order in which Books are Recorded on one Track>

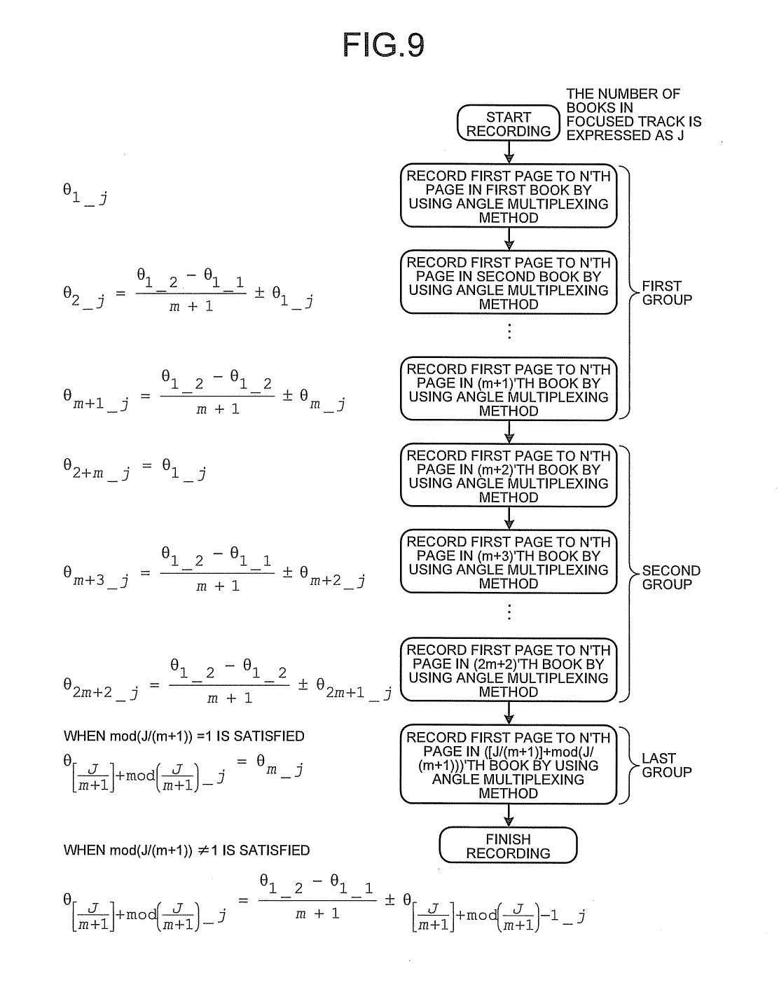

In FIG. 9, on one track, the books are recorded starting with the book positioned at the beginning of the track. In other words, the groups each of which is formed by the consecutive books the total quantity of which is equal to (m+1) are recorded, starting with the beginning of the track.

More specifically, the radiation position, specifying unit 301 specifies a position for the first book. The incident angle obtaining unit 303 obtains the incident angles of the reference beam corresponding to the N pages to be recorded into the first book. After that, the recording controlling unit 311 records the information into the position specified for the book by using the obtained incident angles.

Subsequently, the radiation position specifying unit 301 specifies a position for the second book. The incident angle obtaining unit 303 obtains the incident angles of the reference beam corresponding to the N pages to be recorded into the second book. The recording controlling unit 311 records the information by using the position and the incident angles.

Up to the (m+1)'th book, a position is specified for each of the books and the incident angles are obtained, so that the recording process is repeatedly performed. The (m+2)'th book and the books thereafter are recorded by using the set of incident angles corresponding to the books from the first book to the (m+1)'th book, respectively.

To reproduce the information from the recording medium on which the recording process has been performed in the recording order shown in FIG. 9, the reference beam is radiated by selecting the books in the same order as the one used during the recording process.

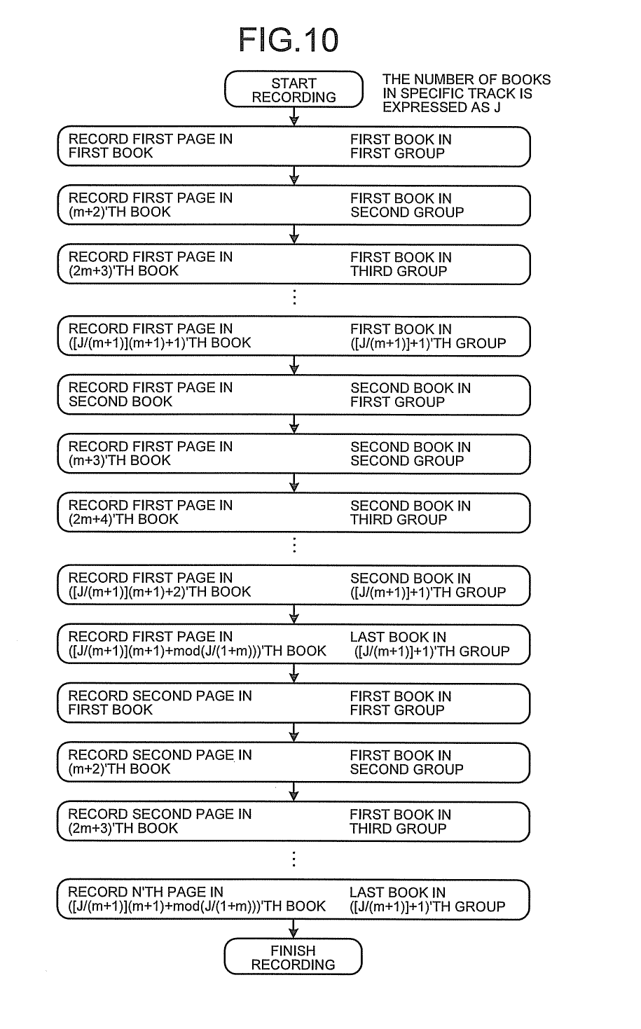

In the example shown in FIG. 10, after the first page in the first book has been recorded, the recording position is moved toward the end of the track by a distance expressed as (1+m)×a, so that the first page in the (2+m)'th book is recorded therein. In other words, the recording process is repeatedly performed by moving the recording position by the distance (1+m)×a every time one page has been recorded.

More specifically, the radiation position specifying unit 301 specifies a position for the first book. The incident angle obtaining unit 303 obtains the incident angles of the reference beam corresponding to the N pages to be recorded into the first book. After that, the recording controlling unit 311 records the information into the position specified for the book by using the obtained incident angles.

Subsequently, the radiation position specifying unit 301 specifies a position for the (m+2)'th book. Because the set of incident angles of the reference beam used for the (m+2)'th book is equal to the set of incident angles of the reference beam used for the first book, the incident angle obtaining unit 303 does not obtain any new incident angles. The recording controlling unit 311 records the information into the position specified for the book, by causing the information beam and the reference beam to be radiated at the incident angles that have already been obtained.

After all the books for which mutually the same set of incident angles is used have been recorded, the second book is recorded. In this situation, the radiation position specifying unit 301 specifies a position for the book. The incident angle obtaining unit 303 obtains the incident angles. The recording controlling unit 311 records the information into the specified position by causing the information beam and the reference beam to be radiated at the obtained incident angles.

After that, the information in the (m+3)'th book is recorded by using the same set of incident angles as the set used for recording the second book.

In the example shown in FIG. 9, a predetermined value is either uniformly added to or uniformly subtracted from the incident angles of the reference beam used for the mutually different books within one group. In contrast, in the example shown in FIG. 10, a predetermined value is either uniformly added to or uniformly subtracted from the incident angles of the reference beam that are used not only for the mutually different books within one group, but also for the mutually different books on one track.

The exemplary embodiments of the present invention have been explained above; however, the present invention is not limited to these exemplary embodiments. It is possible to apply modifications to the exemplary embodiments without departing from the gist of the present invention.

The optical information recording apparatus, the optical information reproducing apparatus, the optical information recording method, and the optical information reproducing method according to the present invention described above make it possible to provide an optical information recording apparatus, an optical information reproducing apparatus, an optical information recording method, and an optical information reproducing method that are able to reduce the noises from the holograms that have been recorded into the adjacent recording spots, while the hologram recording method that employs the angle multiplexing method is used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information recording apparatus comprising:
a first optical system that radiates an information beam onto a recording medium;
a second optical system that radiates a plurality of reference beams onto the recording medium;
a radiated position specifying unit that specifies a plurality of recording spots positioned within a radiation range of the reference beams, when an incident angle of the reference beams at which the reference beams become incident onto the recording medium is a largest one among all incident angles of the reference beams;
an incident angle specifying unit that specifies an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of the information beam on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; and
a controlling unit that controls the reference beams becoming incident at the incident angle of the reference beams specified by the incident angle obtaining unit.

2. The apparatus according to claim 1, wherein
the recording spots are positioned at predetermined intervals on a track of the recording medium, and
the incident angle obtaining unit specifies an incident angle of the reference beams used for recording a first (i=1) interference fringe into a third recording spot that is an (m+1)'th recording spot after the first recording spot, as an incident angle of the reference beams used for recording a first (i=1) interference fringe into the first recording spot.

3. The apparatus according to claim 2, wherein the incident angle obtaining unit specifies an incident angle of the reference beams used for recording a first (i=1) interference fringe into a recording spot that is positioned at an end of the track, as an incident angle of the reference beams used for recording a first (i=1) interference fringe into an m'th recording spot counted from a beginning of the track, when a remainder of dividing a first value by a second value is 1, where the first value is a result of dividing a length of the track by a length of each of the predetermined intervals, whereas the second value is a result of adding 1 to the value m.

4. The apparatus according to claim 3, wherein the controlling unit controls so that information is sequentially recorded into a plurality of recording spots for which a mutually same incident angle of the reference beams is used to record a first (i=1) interference fringe, starting with one of the recording spots positioned at the beginning of the track.

5. The apparatus according to claim 3, wherein the controlling unit controls so that information is sequentially recorded into each recording spot groups including a plurality of recording spots for which a mutually same incident angle of the reference beams is used to record a first (i=1) interference fringe, starting with one of the recording spots positioned at the beginning of the track.

6. The apparatus according to claim 1, wherein the value m is a value obtained by dividing a first value by a second value, where the first value is a shortest distance between the edge of the radiation range of the reference beams obtained when the incident angle of the reference beams is the largest one among all the incident angles of the reference beams and the edge of the beam waist on the plane that contains the beam waist plane of the information beam on the recording medium and that extends parallel to the beam waist plane, whereas the second value is a length of the beam waist in a direction of the shortest distance.

7. The apparatus according to claim 1, wherein the controlling unit controls the incident angle of the reference beams at which the reference beams become incident onto the recording medium by rotating the recording medium.

8. The apparatus according to claim 1, wherein the controlling unit controls the incident angle of the reference beams at which the reference beams become incident onto the recording medium by controlling a radiation angle of the reference beams used by the second optical system.

9. An optical information reproducing apparatus comprising:
a second optical system that radiates a reference beams onto a recording medium;
a radiation position specifying unit that specifies positions of a plurality of recording spots positioned within a radiation range of the reference beams, when an incident angle of the reference beams at which the reference beams becomes incident onto the recording medium is a largest one among all incident angles of the reference beams;
an incident angle obtaining unit that specifies an incident angle of the reference beams that is used for recording an i'th interference fringe into a second recording spot adjacent to a first recording spot, as a value obtained by adding a product of 1/(1+m) and an absolute value of a difference between an incident angle of a first reference beams used for recording an i'th interference fringe into the first recording spot and an incident angle of a second reference beams used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of an information beam radiated on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams;
a controlling unit that controls so that the information beam and the reference beams are radiated to a radiation position specified by the position obtaining unit and so that the reference beams become incident onto the recording medium at the incident angle of the reference beams specified by the incident angle obtaining unit; and
a diffracted beam separating unit that separates diffracted beams that are output from the recording medium as a result of the reference beams controlled by the controlling unit, so that the separated diffracted beams respectively correspond to the positions of the recording spots.

10. The apparatus according to claim 9, wherein
the recording spots are positioned at predetermined intervals on a track of the recording medium, and
the incident angle obtaining unit specifies an incident angle of the reference beams used for recording a first (i=1) interference fringe into a third recording spot that is an (m+1)'th recording spot after the first recording spot, as an incident angle of the reference beams used for recording a first (i=1) interference fringe into the first recording spot.

11. The apparatus according to claim 10, wherein the incident angle obtaining unit specifies an incident angle of the reference beams used for recording a first (i=1) interference fringe into a recording spot that is positioned at an end of the track, as an incident angle of the reference beams used for recording a first (i=1) interference fringe into an m'th recording spot counted from a beginning of the track, when a remainder of dividing a first value by a second value is 1, where the first value is a result of dividing a length of the track by a length of each of the predetermined intervals, whereas the second value is a result of adding 1 to the value m.

12. The apparatus according to claim 11, wherein the controlling unit controls so that information is sequentially reproduced from a plurality of recording spots for which a mutually same incident angle of the reference beams is used to record a first (i=1) interference fringe, starting with one of the recording spots positioned at the beginning of the track.

13. The apparatus according to claim 11, wherein the controlling unit controls so that information is sequentially reproduced from for each recording spot groups composed of a plurality of recording spots for which a mutually same incident angle of the reference beams is used to record a first (i=1) interference fringe, starting with one of the recording spots positioned at the beginning of the track.

14. The apparatus according to claim 9, wherein the value m is a value obtained by dividing a first value by a second value, where the first value is a shortest distance between the edge of the radiation range of the reference beams obtained when the incident angle of the reference beams is the largest one among all the incident angles of the reference beams and the edge of the beam waist on the plane that contains the beam waist plane of the information beam on the recording medium and that extends parallel to the beam waist plane, whereas the second value is a length of the beam waist in a direction of the shortest distance.

15. The apparatus according to claim 9, wherein the controlling unit controls the incident angle of the reference beams at which the reference beams become incident onto the recording medium by rotating the recording medium.

16. The apparatus according to claim 9, wherein the controlling unit controls the incident angle of the reference beams at which the reference beams becomes incident onto the recording medium by controlling a radiation angle of the reference beams used by the second optical system.

17. An optical information recording method comprising:
specifying a plurality of recording spots positioned within a radiation range of reference beams, when an incident angle of the reference beams at which the reference beams become incident onto a recording medium is a largest one among all incident angles of the reference beams;
specifying an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of the information beam on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams; and
controlling so that the information beam and the reference beams are radiated to the specified radiation position of the recording spots and so that the reference beams becomes incident onto the recording medium at the incident angle of the reference beams specified by the incident angle specifying.

18. The method according to claim 17, wherein
the recording spots are positioned at predetermined intervals on a track of the recording medium, and
an incident angle of the reference beams used for recording a first (i=1) interference fringe into a third recording spot that is an (m+1)'th recording spot after the first recording spot, is specified as an incident angle of the reference beams used for recording a first (i′1) interference fringe into the first recording spot.

19. An optical information reproducing method comprising:
obtaining positions of a plurality of recording spots positioned within a radiation range of reference beams, when an incident angle of the reference beams at which the reference beams become incident onto a recording medium is a largest one among all incident angles of the reference beams;
specifying an incident angle of the reference beams that is used for recording an i'th interference fringe into a second recording spot adjacent to a first recording spot, as a value obtained by adding a product of 1/(1+m) and an absolute value of a difference between an incident angle of a first reference beam used for recording an i'th interference fringe into the first recording spot and an incident angle of a second reference beam used for recording an (i+1)'th interference fringe into the first recording spot, where m is a value indicating how many recording spots are contained between an edge of the radiation range of the reference beams obtained when the incident angle of the reference beams is the largest one among all the incident angles of the reference beams and an edge of a beam waist, on a plane that contains a beam waist plane of an information beam radiated on the recording medium and that extends parallel to the beam waist plane, N is a value indicating how many interference fringes are recorded into each of the recording spots, and i is any one of ordinal numbers that are integers from 1 to N that respectively correspond to the mutually different interference fringes that are recorded into each of the recording spots, the ordinal numbers being assigned in an ascending order of the incident angles of the reference beams;
controlling so that the information beam and the reference beams are radiated to the specified radiation positions of the recording spots and so that the reference beams become incident onto the recording medium at the incident angle of the reference beams specified by the incident angle specifying; and
separating diffracted beams that are output from the recording medium as a result of the controlled reference beams, so that the separated diffracted beams respectively correspond to the positions of the recording spots.

20. The method according to claim 19, wherein
the recording spots are positioned at predetermined intervals on a track of the recording medium, and
an incident angle of the reference beams used for recording a first (i=1) interference fringe into a third recording spot that is an (m+1)'th recording spot after the first recording spot, is specified as an incident angle of the reference beams used for recording a first (i=1) interference fringe into the first recording spot.
